(19) United States
(12) Patent Application Publication
(10) Pub. No.: US 2025/0089870 A1
(43) Pub. Date: Mar. 20, 2025

(54) Modular Police Vehicle Trunk Organizer System

(71) Applicants: Michael Waters, Parker, CO (US); Steven J. Palmer, Colorado Springs, CO (US)

(72) Inventors: Michael Waters, Parker, CO (US); Steven J. Palmer, Colorado Springs, CO (US)

(21) Appl. No.: 18/816,852

(22) Filed: Aug. 27, 2024

Related U.S. Application Data
(60) Provisional application No. 63/583,713, filed on Sep. 19, 2023.

(51) Int. Cl. A45C 13/30; B60R 5/04

(52) U.S. Cl. CPC A45C 13/30; B60R 5/04

(57) ABSTRACT

A device is disclosed for enhancing storage within service vehicles, comprising a base board equipped with a plurality of pouches and Modular Lightweight Load-carrying Equipment (MOLLE) straps, which facilitate versatile attachment and organization of equipment. The base board features hinges on its left and right sides, providing flexibility by allowing separation at the center for adaptable deployment. Additionally, the base board incorporates one or more mounting holes to ensure secure attachment within the vehicle. The base board may also include Velcro to further augment the device's organizational capabilities, ensuring a stable and customizable configuration.

### FIELD OF THE INVENTION

The present invention generally relates to the field of vehicle organization and, more particularly, to a novel system and apparatus for managing and organizing equipment and miscellaneous items within the trunk of police vehicles or similar service vehicles.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention discloses an innovative organizational device specifically designed to enhance storage efficiency within service vehicles, such as those utilized by law enforcement and emergency services. The device features a sturdy base board serving as the primary structural element to which various organizational components are attached.

A distinctive aspect of this invention is the integration of multiple pouches and Modular Lightweight Load-carrying Equipment (MOLLE) straps. These elements allow for a versatile and customizable configuration, enabling secure and efficient organization of a wide range of equipment within the vehicle.

In a some embodiments, the base board is equipped with hinges on both the left and right sides. This configuration permits the board to bifurcate at the center, offering flexible deployment and installation options tailored to various vehicle setups or user requirements.

Furthermore, the base board may incorporate one or more mounting holes to ensure robust attachment within the vehicle. To augment its organizational capabilities and adaptability, the base board may also include Velcro, providing additional securing options for diverse equipment types.

The present invention effectively addresses the limitations of conventional storage devices by offering a customizable, adaptable solution that ensures quick accessibility and enhanced protection of vital equipment required in dynamic and critical operational environments.

### BACKGROUND OF THE INVENTION

In the domain of law enforcement, there exists a pronounced need for an enhanced system for organizing equipment within police vehicles. The trunk space of these vehicles frequently serves as a repository for a comprehensive array of items essential for operational duties, including but not limited to safety gear, medical supplies, tools, firearms, electronics, and critical documents. Typically, these items are placed within the trunk without any systematic order, resulting in a cluttered and disorganized environment. Such disorganization substantially impedes the ability of officers to swiftly locate necessary equipment during emergencies, thereby delaying response times. Additionally, this lack of organization can result in equipment being damaged or lost, leading to increased replacement costs.

Attempts to address this issue with conventional solutions, such as standard containers or bins, have proven inadequate. These solutions fail to cater to the specific needs of law enforcement personnel, resulting in inefficient space utilization and inadequate protection of equipment, while also limiting accessibility. Furthermore, the variability in requirements across different police departments or jurisdictions-arising from distinct operational duties, regional considerations, and vehicle models-precludes a one-size-fits-all approach.

Given these challenges, there is a significant demand for an improved trunk organization system specifically for police and similar service vehicles. Such a system should facilitate the rapid access and location of equipment, provide effective protection for sensitive items, optimize space utilization, and offer the flexibility to adapt to diverse requirements and vehicle models.

The present invention aims to address these needs by offering a comprehensive solution that improves the organizational efficiency and operational effectiveness of law enforcement vehicles through a well-organized, accessible, and protective trunk environment. It is specifically devised to overcome the shortcomings associated with conventional devices and methods, providing significant enhancements to these existing systems.

### BRIEF DESCRIPTION OF THE DRAWINGS

FIG. 1 is an illustration of one embodiment of the present invention installed on a car trunk.

FIG. 2 is an illustration of one embodiment of the present invention showing pouches and straps attached to a base board.

FIG. 3 is an illustration of one embodiment of the present invention showing the pouches and straps separated from the base board.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible.

Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present invention 100 comprises several key components, each designed to enhance the organization and accessibility of police equipment within a vehicle trunk 4.

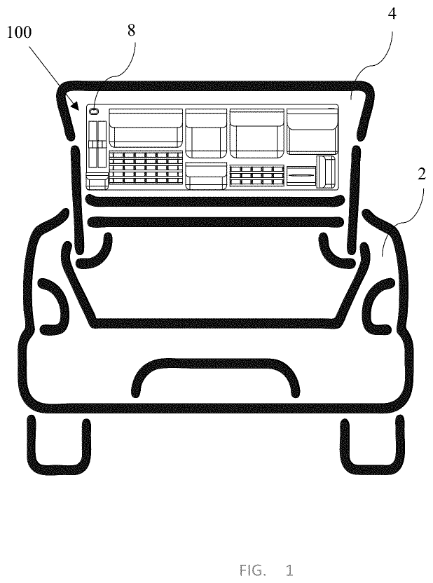

In preferred embodiment, as shown in FIGS. 1 to 3, the present invention 100 comprises a base board 10, a plurality of pouches 30, and a plurality of Modular Lightweight Load-carrying Equipment (MOLLE) Straps 20.

The described components collectively form a robust and efficient trunk organization system, tailored to enhance the operational readiness and efficiency of law enforcement personnel by maximizing space utility and ensuring quick accessibility to crucial equipment.

### Base Board 10

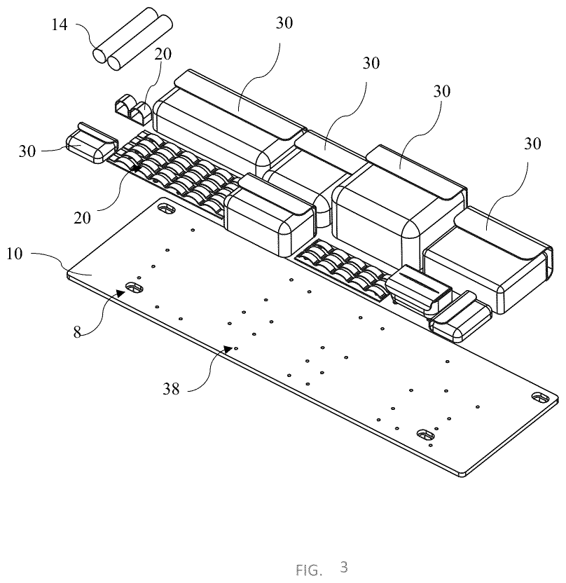

As shown in FIG. 3, in one embodiment, the present invention 100 comprises a Base Board 10, which serves as the foundational structure of the trunk organization system.

The Base Board 10 can be made from durable materials such as high-strength plastic, capable of withstanding rigorous conditions encountered in law enforcement operations.

In some embodiments, the Base Board 10 is configured for secure attachment to the interior surface of a police vehicle's 2 trunk lid 4, as shown in FIG. 1, utilizing specialized mounting hardware that ensures stability and reliability. The strategic placement of the Base Board 10 optimizes the use of space, facilitating immediate access to essential equipment when the trunk lid is opened.

In an alternative embodiment, the present invention 100 can be designed for sport utility vehicles (SUVs) 2. This embodiment features an innovative configuration where the Modular Police Trunk Organizer System mounts directly to the top of a weapons vault inside the vehicle 2. Instead of utilizing a traditional single-piece substrate, this design includes a hinged mechanism. The Base Board 10 is hinged at the left and right sides of the mount and separates at the center of the substrate. For example, Base Board 10 may comprise two panels operatively connected by a fastener at the central area to collectively establish Base Board 10. This allows for the utilization of the Modular Police Trunk Organizer System's pouches 30 and concurrently enables the operator to access the storage area on top of the weapons vault. This configuration enhances the system's functional utility by facilitating organized storage and rapid accessibility of police equipment while maintaining the usability of the underlying storage space.

### Detachable Pouches 30

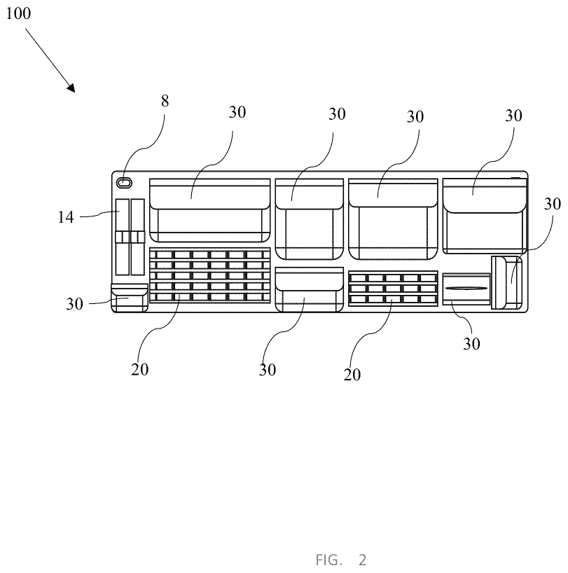

As shown in FIGS. 2-3, the present invention 100 further comprises a plurality of detachable pouches 30, each mounted onto the Base Board 10.

In some embodiments, these pouches 30 are designed to accommodate a diverse array of police equipment. The pouches 30 may be attached using Velcro or other hardware, providing flexibility in their arrangement. This allows law enforcement personnel to customize the configuration to align with departmental requirements or personal preferences. In some embodiment, the detachability of the pouches 30 allows for rapid swapping of equipment sets, adapting to varying operational demands.

### MOLLE Straps 20

As shown in FIGS. 2-3, the present invention 100 comprises integrated Modular Lightweight Load-carrying Equipment (MOLLE) straps 20, enhancing the organizational capacity of the system.

In preferred embodiments, these MOLLE straps 20 are affixed to the Base Board 10, allowing for secure attachment of additional equipment beyond the fixed pouches 30. MOLLE straps 20 are widely recognized for their adaptability in military and law enforcement applications, and in this embodiment, they provide a versatile means to secure various tools, devices, and accessories necessary for police operations.

### Equipment Accommodation

In one embodiment, the pouches 30 and MOLLE straps 20 of the present invention 100 are specifically designed to hold a wide range of police equipment. These include, but are not limited to, ammunition, first aid kits, NARCAN (Naloxone), disposable gloves, and other critical tools such as hand sanitizers, traffic vests, and turbo flares.

In some embodiment, each pouch is tailor-made to securely house its designated equipment, with features such as slits for easy access, ensuring that items remain fixed in place during vehicle movement.

In one embodiment, as shown in FIGS. 2-3, the present invention 100 may comprises a base board 10, which serves as the primary structural element and includes an array of pre-drilled holes 38 and designated mounting points 8. The pouches 30, constructed from a flexible yet sturdy material, are modular storage units designed to hold various items and are equipped with attachment loops or tabs that align with the mounting points 8 on the base board 10. The straps 20, made from high-tensile strength materials, are threaded through the attachment loops on the pouches 30 and the corresponding mounting points 8 on the base board 10, with their ends fastened using buckles, clips, or hook-and-loop fasteners to provide adjustable tension and secure the pouches firmly in place. Additionally, the assembly includes an additional component 14, which can be a container, mounted on the left side of the base board 10 using similar attachment methods as the pouches, ensuring it remains firmly in place. The arrangement and attachment of these components create a versatile and secure organizational solution, with the base board 10 providing a robust foundation for the modular pouches 30 and additional component 14, all securely fastened by the straps 20 through the mounting points 8 and holes 38.

The present invention 100 may further comprise a series of mounting and securement mechanisms that facilitate the stable installation of the Base Board 10 and attached components within the vehicle trunk 4.

In some embodiments, multiple mounting points 8 and holes 38 are utilized to ensure a firm attachment, while options like Velcro provide temporary securement for easy detachment and rearrangement of specific items, such as a first aid kit for use outside the vehicle 2.

Although the invention has been explained in relation to its preferred embodiment, it is to be understood that many other possible modifications and variations can be made without departing from the spirit and scope of the invention.

What is claimed is:

1. A device comprising:
a base board,
a plurality of pouches attached to the base board, and
a plurality of Modular Lightweight Load-carrying Equipment (MOLLE) Straps attached to the base board.

2. The device as claimed in claim 1, wherein the base board includes hinges at the left and right sides of the base board.

3. The device as claimed in claim 2, wherein the base board is configured to separate at the center.

4. The device as claimed in claim 1, wherein the base board includes one ore more multiple mounting holes to ensure a firm attachment.

5. The device as claimed in claim 1, wherein the base board includes Velcro.

6. A device comprising:
a base board having hinges at the left and right sides of the base board,
a plurality of pouches attached to the base board, and
a plurality of Modular Lightweight Load-carrying Equipment (MOLLE) Straps attached to the base board.

7. The device as claimed in claim 6, wherein the base board is configured to separate at the center.

8. The device as claimed in claim 7, wherein the base board includes one or more multiple mounting holes to ensure a firm attachment.

9. The device as claimed in claim 6, wherein the base board includes Velcro.

10. The device as claimed in claim 6, wherein the device includes at least four pouches attached to the top portion of the base board.

11. The device as claimed in claim 6, wherein the device includes at least three pouches attached to the bottom portion of the base board.

12. The device as claimed in claim 6, wherein the device includes at least four pouches attached to the top portion of the base board and at least three pouches attached to the bottom portion of the base board.

13. A device comprising:
a base board having an array of holes and mounting points,
a plurality of pouches having attachment loops attached to the base board,
a plurality of Modular Lightweight Load-carrying Equipment (MOLLE) Straps attached to the base board, the MOLLE Straps threaded through the attachment loops on the plurality of pouches and the corresponding mounting points on the base board, with their ends fastened using buckles, and
a container, mounted on the left side of the base board.

14. The device as claimed in claim 13, wherein the base board includes hinges at the left and right sides of the base board.

15. The device as claimed in claim 14, wherein the base board is configured to separate at the center.

16. The device as claimed in claim 13, wherein the base board includes one or more multiple mounting holes to ensure a firm attachment.

17. The device as claimed in claim 14, wherein the base board includes Velcro.

18. The device as claimed in claim 13, wherein the device includes at least four pouches attached to the top portion of the base board.

19. The device as claimed in claim 13, wherein the device includes at least three pouches attached to the bottom portion of the base board.

20. The device as claimed in claim 13, wherein the device includes at least four pouches attached to the top portion of the base board and at least three pouches attached to the bottom portion of the base board.
